(19) United States
(12) Patent Application Publication
(10) Pub. No.: US 2026/0135960 A1
(43) Pub. Date: May 14, 2026

(54) MEDIUM TRANSPORT DEVICE AND IMAGE READING DEVICE

(71) Applicant: SEIKO EPSON CORPORATION, TOKYO (JP)

(72) Inventor: Masaya YAMASAKI, KITAKYUSHU-SHI (JP)

(21) Appl. No.: 19/386,295

(22) Filed: Nov. 12, 2025

(30) Foreign Application Priority Data
Nov. 12, 2024 (JP) 2024-197365

(51) Int. Cl. H04N 1/00

(52) U.S. Cl. CPC H04N 1/00652; H04N 1/00602; H04N 1/00604; H04N 1/00615; H04N 1/00631; H04N 1/00734; H04N 1/00779; H04N 1/00771; H04N 2201/0081

(57) ABSTRACT

A medium transport device 1 includes a discharge section 31 including a discharge roller 17 configured to discharge a medium 2; a discharge tray 19 including a placement surface 32 that supports the medium 2 discharged from the discharge section 31; and a stopper 101 that is provided on the discharge tray 19 and that is configured to be displaced between a first state in which the stopper 101 protrudes from the placement surface 32 to restrict movement of discharged medium 2 in a discharge direction 18 and a second state in which the stopper 101 does not protrude from the placement surface 32 to allow movement of the medium 2 in the discharge direction 18, wherein the discharge section 31 is configured to decelerate a discharge speed of the medium 2 by the discharge roller 17 when discharging the medium 2 from a first speed to a second speed and a degree of deceleration from the first speed to the second speed is smaller when the stopper 101 is in the first state than when the stopper 101 is in the second state.

The present application is based on, and claims priority from JP Application Serial Number 2024-197365, filed November 12, 2024, the disclosure of which is hereby incorporated by reference herein in its entirety.

### BACKGROUND

### 1. Technical Field

The present disclosure relates to a medium transport device and an image reading device.

### 2. Related Art

In the related art, various medium transport device capable of transporting a medium have been used. Among these, there is an image reading device that reads an image on a medium being transported. For example, JP-A-2023-137046 discloses a medium transport device including an imaging device that reads an image on a medium being transported.

The medium transport device disclosed in JP-A-2023-137046 is configured to be capable of discharging sheets of a medium of different sizes, and the medium discharged from a discharge roller is supported on a discharge tray. In the related art medium transport device such as the medium transport device disclosed in JP-A-2023-137046, when a plurality of sheets of a medium are consecutively transported, there is a concern about transportability, which is the presence or absence of a problem associated with the transport of the medium, such as the order of the medium being changed in the process of discharging the medium from the discharge roller toward the discharge tray. In the medium transport device disclosed in JP-A-2023-137046, in order to improve alignment of the medium on the discharge tray as an example of transportability of the medium, a discharge speed of the medium by the discharge roller is configured to be decelerated from a first transport speed to a second transport speed. However, if a discharge speed of the medium by the discharge roller is significantly decelerated, power consumption in a motor or the like that drives the discharge roller increases.

### SUMMARY

A medium transport device of the present disclosure for overcoming the above-described problem includes a discharge section including a discharge roller configured to discharge a medium; a discharge tray including a placement surface that supports the medium discharged from the discharge section; and a stopper that is provided on the discharge tray and that is configured to be displaced between a first state in which the stopper protrudes from the placement surface to restrict movement of discharged medium in a discharge direction and a second state in which the stopper does not protrude from the placement surface to allow movement of the medium in the discharge direction, wherein the discharge section is configured to decelerate a discharge speed of the medium by the discharge roller when discharging the medium from a first speed to a second speed and a degree of deceleration from the first speed to the second speed is smaller when the stopper is in the first state than when the stopper is in the second state.

Another medium transport device of the present disclosure for overcoming the above-described problem includes a feed tray that supports a medium; a feeding section that feeds the medium supported on the feed tray; a discharge section configured to discharge the medium fed by the feeding section; a discharge tray including a placement surface that supports the medium discharged from the discharge section; a photographing section that photographs the medium; and a control section, wherein the control section causes the photographing section to photograph the medium both before the medium is discharged from the discharge section and during or after the medium is discharged from the discharge section, and determines a state of the medium after the medium is discharged from the discharge section based on image data of one surface of the medium before the medium is discharged from the discharge section and image data of the one surface of the medium during or after the medium is discharged from the discharge section.

### BRIEF DESCRIPTION OF THE DRAWINGS

FIG. 1 is a side view of an image reading device according to a first embodiment of the present disclosure.

FIG. 2 is a block diagram of the image reading device of FIG. 1.

FIG. 3 is a side view showing a vicinity of a discharge tray of the image reading device of FIG. 1, and is a diagram for explaining when a stopper is in a first state and when a stopper is in a second state.

FIG. 4 is a plan view showing a vicinity of the discharge tray of the image reading device of FIG. 1, and is a diagram for explaining a deploy and store mechanism of the stopper.

FIG. 5 is a plan view showing a vicinity of the discharge tray of the image reading device of FIG. 1, and is a diagram for explaining a movement mechanism of edge guides.

FIG. 6 is a side view showing a vicinity of the discharge tray of the image reading device of FIG. 1, in which the stopper is in the first state when a medium having a large size is used.

FIG. 7 is a side view showing a vicinity of the discharge tray of the image reading device of FIG. 1, and is a diagram showing a state where a plurality of sheets of the medium having a large size are further stacked from the state of FIG. 6.

FIG. 8 is a schematic side view of the image reading device of FIG. 1.

FIG. 9 is a flowchart showing a flow of determining whether to set the stopper to the first state or the second

state in the control section and discharging a medium to the discharge tray using the image reading device of FIG. 1.

FIG. 10 is a flowchart showing a flow of determining a width of the medium in a control section from a photographic result of a camera using the image reading device of FIG. 1 and adjusting positions of edge guides.

FIG. 11 is a side view showing a vicinity of the discharge tray of an image reading device according to a second embodiment of the present disclosure, in which the stopper is in the first state when the medium having a large size is used.

FIG. 12 is a side view showing a vicinity of the discharge tray of the image reading device of FIG. 11, and is a diagram showing a state where a plurality of sheets of the medium having a large size are further stacked from the state of FIG. 11.

FIG. 13 is a schematic side view of an image reading device according to a third embodiment of the present disclosure.

FIG. 14 is a schematic side view of an image reading device according to a fourth embodiment of the present disclosure.

FIG. 15 is a schematic side view of an image reading device according to a fifth embodiment of the present disclosure.

### DESCRIPTION OF EMBODIMENTS

First, the present disclosure will be schematically described.

A medium transport device according to a first aspect of the present disclosure for overcoming the above-described problem includes a discharge section including a discharge roller configured to discharge a medium; a discharge tray including a placement surface that supports the medium discharged from the discharge section; and a stopper that is provided on the discharge tray and that is configured to be displaced between a first state in which the stopper protrudes from the placement surface to restrict movement of discharged medium in a discharge direction and a second state in which the stopper does not protrude from the placement surface to allow movement of the medium in the discharge direction, wherein the discharge section is configured to decelerate a discharge speed of the medium by the discharge roller when discharging the medium from a first speed to a second speed and a degree of deceleration from the first speed to the second speed is smaller when the stopper is in the first state than when the stopper is in the second state.

According to the present aspect, the discharge tray includes the stopper configured to be displaced between a first state in which the stopper protrudes from the placement surface to restrict movement of discharged medium in a discharge direction and a second state in which the stopper does not protrude from the placement surface to allow movement of the medium in the discharge direction. With such a configuration, by setting the stopper to the first state as necessary, it is possible to suppress some of the medium discharged to the discharge tray from moving too much in the discharge direction when consecutively placing the medium on the discharge tray. If a part of the medium discharged to the discharge tray moves too much in the discharge direction, there is a possibility that the order of the medium is changed or the medium is turned over, but this can be suppressed. That is, transportability of the medium can be improved. According to the present aspect, the discharge section is configured to decelerate a discharge speed of the medium by the discharge roller when discharging the medium from the first speed to the second speed and a degree of deceleration from the first speed to the second speed is smaller when the stopper is in the first state than when the stopper is in the second state. With such a configuration, when the stopper can suppress the medium from moving more than expected in the discharge direction when the medium is discharged (first state), a degree of deceleration can be reduced to suppress an increase in power consumption. That is, it is possible to improve transportability of the medium while suppressing power consumption.

A medium transport device according to a second aspect of the present disclosure is an aspect according to the first aspect, and the stopper is configured to be displaced between the first state and the second state depending on a type of the medium.

According to the present aspect, the stopper is configured to be displaced between the first state and the second state depending on a type of the medium. There are cases where the stopper needs to be in the first state and cases where the stopper does not need to be in the first state depending on a type of the medium, but with such a configuration, the stopper can be suitably displaced to the first state and the second state depending on the type of the medium.

A medium transport device according to a third aspect of the present disclosure is an aspect according to the first or second aspect, and the stopper is configured to change a position in the discharge direction depending on a size of the medium.

According to the present aspect, the stopper is configured to change a position in the discharge direction depending on a size of the medium. With such a configuration, the stopper can be arranged on a downstream side in the discharge direction when a size of the medium is large, and the stopper can be arranged on an upstream side in the discharge direction when the size of the medium is small. That is, it is possible to improve alignment of the medium on the placement surface with respect to a medium having various sizes, and it is possible to suitably improve transportability of the medium.

A medium transport device according to a fourth aspect of the present disclosure is an aspect according to any one of the first to third aspects, and the stopper is configured to change a protrusion amount with respect to the placement surface in the first state depending on a placed amount of the medium that was placed on the placement surface.

According to the present aspect, the stopper is configured to change a protrusion amount with respect to the placement surface in the first state depending on a placed amount of the medium that was placed on the placement surface. With such a configuration, a protrusion amount of the stopper can be reduced when a placed amount of the medium is small, and the protrusion amount of the stopper can be increased as the placed amount of the medium increases. That is, it is possible to improve alignment of the medium on the placement surface depending on a placed amount of the medium, and it is possible to suitably improve transportability of the medium.

A medium transport device according to a fifth aspect of the present disclosure is an aspect according to any one of the first to fourth aspects, and the discharge tray is configured to change a position of the placement surface with respect to the discharge section in a placement direction of the medium depending on a placed amount of the medium that was placed on the placement surface.

According to the present aspect, the discharge tray is configured to change a position of the placement surface with respect to the discharge section in the placement direction of the medium depending on a placed amount of the medium that was placed on the placement surface. With such a configuration, a position of the placement surface can be set to a position close to the discharge section in a case where a placed amount of the medium is small, and a position of the placement surface can be set to a position far from the discharge section as the placed amount of the medium increases. That is, it is possible to improve alignment of the medium on the placement surface depending on a placed amount of the medium, and it is possible to suitably improve transportability of the medium.

A medium transport device according to a sixth aspect of the present disclosure is an aspect according to any one of the first to fifth aspects, and the medium transport device further includes a photographing section that photographs the medium and a displacement mechanism that displaces the stopper between the first state and the second state, wherein the displacement mechanism is configured to displace the stopper between the first state and the second state based on image data of the medium photographed by the photographing section.

According to the present aspect, the medium transport device includes the photographing section that photographs the medium and the displacement mechanism that displaces the stopper between the first state and the second state. The displacement mechanism is configured to be able to displace the stopper between the first state and the second state based on image data of the medium photographed by the photographing section. With such a configuration, the stopper can be suitably displaced between first state and the second state based on image data of the medium photographed by the photographing section. That is, it is possible to suitably improve transportability of the medium based on image data of the medium.

A medium transport device according to a seventh aspect of the present disclosure includes a feed tray that supports a medium; a feeding section that feeds the medium supported on the feed tray; a discharge section configured to discharge the medium fed by the feeding section; a discharge tray including a placement surface that supports the medium discharged from the discharge section; a photographing section that photographs the medium; and a control section, wherein the control section causes the photographing section to photograph the medium both before the medium is discharged from the discharge section and during or after the medium is discharged from the discharge section, and determines a state of the medium after the medium is discharged from the discharge section based on image data of one surface of the medium before the medium is discharged from the discharge section and image data of the one surface of the medium during or after the medium is discharged from the discharge section.

According to the present aspect, the medium is photographed both before the medium is discharged from the discharge section and during or after the medium is discharged from the discharge section, and a state of the medium after the medium is discharged is determined based on image data of one surface of the medium before the medium is discharged and image data of the one surface of the medium during or after the medium is discharged. With such a configuration, it is possible to suitably determine a state of the medium after the medium is discharged based on image data of the medium photographed by the photographing section. That is, it is possible to suitably improve transportability of the medium based on image data of the medium. With such a configuration, it is possible to adjust a discharge speed of the medium by the discharge roller and the like based on a determined state of the medium, and it is possible to reduce the opportunity of increasing power consumption by significantly decelerating the discharge speed of the medium by the discharge roller.

A medium transport device according to an eighth aspect of the present disclosure is an aspect according to the seventh aspect, and the control section causes the photographing section to photograph the medium supported on the feed tray and also to photograph the medium being discharged or after being discharged from the discharge section, and determines a state of the medium after the medium is discharged from the discharge section based on image data of the medium supported on the feed tray and image data of the medium being discharged or after being discharged from the discharge section.

According to the present aspect, a state of the medium after the medium is discharged from the discharge section is determined based on image data of the medium supported on the feed tray and image data of the medium being discharged or after being discharged from the discharge section. With such a configuration, by comparing image data of the medium supported on the feed tray with image data of the medium being discharged or after being discharged from the discharge section, it is possible to suitably determine a state of the medium after the medium is discharged from the discharge section, and it is possible to suitably detect the change in the order of the medium, turned over medium, or the like.

A medium transport device according to a ninth aspect of the present disclosure is an aspect according to the seventh aspect, and the control section causes the photographing section to photograph the medium being transported in a transport path from the feed tray to the discharge section and also to photograph the medium being discharged or after being discharged from the discharge section, and determines a state of the medium after the medium is discharged from the discharge section based on image data of the medium being transported on the transport path and image data of the medium being discharged or after being discharged from the discharge section.

According to the present aspect, a state of the medium after the medium is discharged from the discharge section is determined based on image data of the medium being transported on the transport path and image data of the medium being discharged or after being discharged from the discharge section. With such a configuration, by comparing image data of the medium being transported on the transport path with image data of the medium being discharged or after being discharged from the discharge section, it is possible to suitably determine a state of the medium after the medium is discharged from the discharge section, and it is possible to suitably detect the change in the order of the medium, turned over medium, or the like.

A medium transport device according to a tenth aspect of the present disclosure is an aspect according to any one of the seventh to ninth aspects, and the feed tray includes an edge guide configured to move in a direction intersecting a feed direction of the medium and the control section causes the photographing section to photograph the medium supported on the feed tray, and moves the edge guide based on image data of the medium photographed by the photographing section.

According to the present aspect, the edge guide is moved based on image data of the medium supported on the feed tray. With such a configuration, the edge guide can be arranged at a suitable position, alignment of the medium on the feed tray can be improved, and transportability of the medium can be improved.

A medium transport device according to an eleventh aspect of the present disclosure is an aspect according to any one of the seventh to tenth aspects, and the discharge tray includes an edge guide configured to move in a direction intersecting a discharge direction of the medium and the control section causes the photographing section to photograph at least one of the medium supported on the feed tray and the medium supported on the discharge tray, and moves the edge guide based on image data of the medium photographed by the photographing section.

According to the present aspect, the edge guide is moved based on image data of the medium supported on the feed tray or image data of the medium supported on the discharge tray. With such a configuration, the edge guide can be arranged at a suitable position, alignment of the medium on the placement surface can be improved, and transportability of the medium can be improved.

A medium transport device according to a twelfth aspect of the present disclosure is an aspect according to any one of the seventh to eleventh aspects, and the medium transport device further includes a stopper provided on the discharge tray and configured to be displaced between a first state in which the stopper protrudes from the placement surface to restrict movement of the discharged medium in a discharge direction and a second state in which the stopper has dropped down toward the placement surface to allow movement of the medium in the discharge direction, wherein the control section causes the photographing section to photograph the medium supported on the feed tray, and displaces the stopper between the first state and the second state based on image data of the medium supported on the feed tray.

According to the present aspect, the stopper is displaced between the first state and the second state based on image data of the medium supported on the feed tray. With such a configuration, it is possible to suitably determine whether to displace the stopper to the first state or the second state, and by setting the stopper to the first state as necessary, it is possible to suppress some of the medium discharged to the discharge tray from moving too much in the discharge direction when the medium is consecutively placed on the discharge tray. That is, transportability of the medium can be improved.

A medium transport device according to a thirteenth aspect of the present disclosure is an aspect according to any one of the seventh to twelfth aspects, and the control section causes the photographing section to photograph a part of the medium.

According to the present aspect, the photographing section is caused to photograph a part of the medium. With such a configuration, an image data amount of the medium generated by being photographed by the photographing section can be reduced, and data processing time can be shortened.

A medium transport device according to a fourteenth aspect of the present disclosure is an aspect according to any one of the seventh to thirteenth aspects, and the control section determines a state of the medium after the medium is discharged from the discharge section based on a part of image data of one surface of the medium before being discharged from the discharge section and a part of image data of one surface of the medium during or after being discharged from the discharge section.

According to the present aspect, a state of the medium after the medium is discharged from the discharge section is determined based on a part of image data of one surface of the medium before being discharged from the discharge section and a part of image data of one surface of the medium during or after being discharged from the discharge section. With such a configuration, data processing time can be shortened.

An image reading device according to a fifteenth aspect of the present disclosure includes the medium transport device according to any one of the first to fourteenth aspects and an image reading section that reads an image formed on the medium.

According to the present aspect, the image reading device includes the above-described medium transport device and the image reading section that reads an image formed on the medium. Therefore, it is possible to read an image formed on the medium while improving transportability of the medium.

### FIRST EMBODIMENT

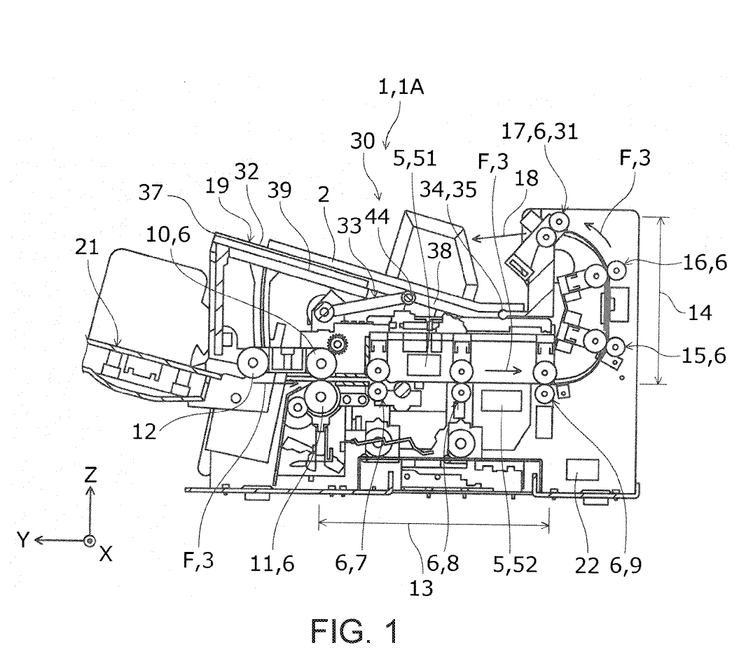

Hereinafter, an embodiment of an image reading device 1 as an example of a medium transport device according to the present disclosure will be described with reference to FIGS. 1 to 10. First, the outline of an image reading device 1A of a first embodiment of the image reading device 1 of the present disclosure will be described with reference to FIG. 1. In the following description, three axes orthogonal to each other are referred to as an X-axis, a Y-axis, and a Z-axis, respectively, as shown in each drawing. A direction indicated by the arrows of the three axes (X, Y, and Z) is a +direction of each direction, and the opposite direction is a -direction. A Z-axis direction corresponds to a vertical direction, that is, a direction in which gravity acts, a +Z direction indicates a vertically upward direction, and a -Z direction indicates a vertically downward direction. An X-axis direction and a Y-axis direction correspond to a horizontal direction, and the X-axis direction corresponds to a width direction. A +Y direction indicates a front direction of the device and a -Y direction indicates a rear direction of the device. A +X direction indicates a right direction of the device and a -X direction indicates a left direction of the device.

The image reading device 1A of the present embodiment is a document scanner capable of reading an image formed on a medium 2. Here, the image formed on the medium 2 means an image visually recorded on the medium 2, and is, for example, a character, a figure, a table, a picture, a photograph, or the like. The medium is not limited to a sheet, and may be a card, a booklet, or the like. The image reading device 1 of the present disclosure is not limited to a scanner, and may be a copy machine, a facsimile machine, or the like.

As illustrated in FIG. 1, the image reading device 1A can be regarded as a medium transport device that transports the medium 2 in a transport direction F along a transport path 3, and includes a reading section 5 that reads an image on the medium 2 being transported. The image reading device 1A includes two reading sections 5, a first reading section 51 and a second reading section 52, which serve as the reading section 5 that reads an image on the medium 2. The first reading section 51 is positioned above the transport path 3 and reads an image on a first surface of the medium 2. The second reading section 52 is positioned below the transport path 3 and reads an image on a second surface opposite to the first surface. The reading section 5 is configured by, for example, a contact image sensor (CIS) type sensor, a charge coupled device (CCD) type sensor, or the like.

The image reading device 1A includes a transport section 6 that transports the medium 2 in the transport direction F along the transport path 3. The image reading device 1A includes, as the transport section 6, a first transport roller pair 7 provided upstream of the first reading section 51, a second transport roller pair 8 provided upstream of the second reading section 52 positioned downstream of the first reading section 51, and a third transport roller pair 9 provided downstream of the second reading section 52. The first transport roller pair 7, the second transport roller pair 8, and the third transport roller pair 9 are each configured by a pair of a drive roller that rotates by power of a drive source such as a motor (not illustrated), and a driven roller.

Upstream in the transport direction F of the first transport roller pair 7, a roller pair including a feed roller 10 and a separation roller 11 is arranged. The feed roller 10 is a drive roller that rotates by power of a drive source such as a motor (not illustrated), and transports the medium 2 in the transport direction F. The separation roller 11 is a drive roller that rotates by power of a drive source (not illustrated), and is a roller that separates one sheet of the medium 2 from a plurality of sheets of the medium 2. Here, the separation roller 11 rotates in a direction in which the medium 2 is fed to an upstream side (+Y direction) in the transport direction F by the power of the drive source. The separation roller 11 includes a torque limiter (not illustrated), and when a torque exceeding a set value is applied to the torque limiter, the separation roller 11 is driven to rotate in a direction of feeding the medium 2 to a downstream side (-Y direction) in the transport direction F. A pickup roller 12 is arranged upstream of the separation roller 11. The pickup roller 12 is a drive roller that rotates by power of a drive source (not illustrated), and picks up the medium 2, and feeds the medium 2 in the transport direction F.

In the image reading device 1A, a U-turn path 14 is provided downstream of a straight path 13 from the feed roller 10 to the third transport roller pair 9, that is, downstream of the third transport roller pair 9. In the U-turn path 14, a fourth transport roller pair 15, a fifth transport roller pair 16, and a discharge roller pair 17 as the transport section 6 are arranged in this order along the transport direction F. The fourth transport roller pair 15, the fifth transport roller pair 16, and the discharge roller pair 17 are also configured by a pair of a drive roller that rotates by power of a drive source (not illustrated), and a driven roller. A discharge tray 19 that receives the medium 2 discharged from the discharge roller pair 17 in a discharge direction 18 is arranged above the straight path 13, and thus, the size of the image reading device 1A is reduced.

The medium 2 on a feed tray 21 is picked up by the pickup roller 12 as a feeding section and is fed in the transport direction F. The feed tray 21 is configured to move up and down by power of a drive source (not illustrated). In a case where the medium 2 set on the feed tray 21 is fed in the transport direction F, first, the feed tray 21 is moved upward (+Z direction) by power transmitted from a drive source (not illustrated), and is stopped in a state where the topmost sheet of the medium 2 is in contact with the pickup roller 12. In this state, the pickup roller 12 rotates to feed the medium 2 in the transport direction F, and a leading edge of the medium 2 reaches a nip position of a roller pair of the feed roller 10 and the separation roller 11.

In a case of a multi-feed state in which a plurality of sheets of the medium 2 are fed, one sheet of the medium 2 is separated by the separation roller 11, the one sheet is transported in the transport direction F by the first transport roller pair 7, and the first reading section 51 reads an image on the first surface of the medium 2. The medium 2 read by the first reading section 51 is transported by the second transport roller pair 8, and the second reading section 52 reads an image on the second surface of the medium 2 opposite to the first surface.

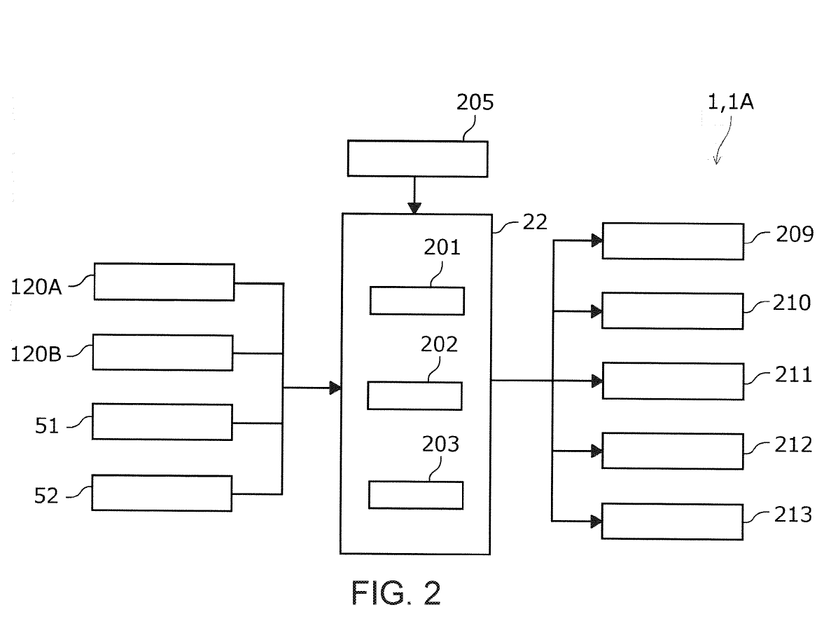

The control section 22 controls the drive of each drive source and a reading operation of the reading section 5 in accordance with the transport of the medium 2. As illustrated in FIG. 2, the control section 22 includes a CPU 201, a ROM 202, a RAM 203, and the like, which will be described in detail later. The CPU 201 performs various arithmetic processes according to a program stored in the ROM 202, and controls an operation of the entire image reading device 1. As the ROM 202, which is an example of a storage unit, a flash ROM, which is a readable and writable non-volatile memory, can be preferably used. Various types of information are temporarily stored in the RAM 203, which is an example of the storage unit.

The image reading device 1A includes a medium discharge device 30. The medium discharge device 30 includes the discharge roller pair 17 as a discharge section 31 that discharges the medium 2, and the discharge tray 19 including a placement surface 32 on which the medium 2 discharged from the discharge section 31 in the discharge direction 18 is supported. The discharge tray 19 is configured to be expandable and contractible in a direction along the placement surface 32. That is, the discharge tray 19 is configured such that a length of the placement surface 32 can be extended. The medium discharge device 30 includes an expansion and contraction changing section 33 that expands and contracts the discharge tray 19. The expansion and contraction changing section 33 is configured to expand and contract the discharge tray 19 depending on a size of the medium 2.

In the present embodiment, the discharge tray 19 is configured to be pivotable in an vertical direction with a base end section 34 as a pivot fulcrum 35. That is, the discharge tray 19 is structured so that the discharge tray 19 can be pivoted by a user lifting a tip end section 37 upward. The discharge tray 19 includes a base tray 38 and an auxiliary tray 39 movable in an expansion and contraction direction with respect to the base tray 38. A protrusion section is provided at a base end of the auxiliary tray 39. The protrusion section is a plate-shaped member that protrudes downward from the auxiliary tray 39.

The expansion and contraction changing section 33 is configured to expand the discharge tray 19 in conjunction with the pivot of the discharge tray 19. When the tip end section 37 of the discharge tray 19 pivots up and down about the base end section 34 as the pivot fulcrum 35, an other end section 44 slides in the expansion and contraction direction along the placement surface 32 while being connected to the base tray 38.

As described above, the image reading device 1A of the present embodiment includes the discharge section 31 including the discharge roller pair 17 as a discharge roller capable of discharging the medium 2, the discharge tray 19 including the placement surface 32 on which the medium 2 discharged from the discharge section 31 is supported, and the reading section 5 (the first reading section 51 and the second reading section 52) as an image reading section that reads an image formed on the medium 2. Here, the image reading device 1A of the present embodiment includes a stopper 101 that is provided on the discharge tray 19 and that is displaceable between a first state in which the stopper 101 protrudes (deploys) from the placement surface 32 to restrict movement of the discharged medium 2 in the discharge direction 18, and a second state in which the stopper 101 does not protrude from the placement surface 32, and in the present embodiment, a second state in which the stopper 101 drops down (is stored) toward the placement surface 32 to allow movement of the medium 2 in the discharge direction 18.

The image reading device 1A of the present embodiment includes such a stopper 101, and thus, by setting the stopper 101 to the first state as necessary, it is possible to suppress some of the medium 2 discharged to the discharge tray 19 from moving too far in the discharge direction 18 when the medium 2 is consecutively placed on the discharge tray 19. When some of the medium 2 discharged to the discharge tray 19 moves too far in the discharge direction 18, there is a possibility that the order of the medium 2 will change or the medium 2 will turn over, but the image reading device 1A of the present embodiment includes such a stopper 101, and thus, it is possible to suppress such a possibility. That is, the image reading device 1A of the present embodiment can improve transportability of the medium 2, and can read an image formed on the medium 2 while improving transportability of the medium 2.

In the image reading device 1A of the present embodiment, the discharge section 31 is configured to be able to decelerate the discharge speed of the medium 2 by the discharge roller pair 17 when discharging the medium 2 from a first speed to a second speed. The image reading device 1A of the present embodiment is configured such that, under the control of the control section 22, the degree of deceleration from the first speed to the second speed is smaller when the stopper 101 is in the first state than when the stopper 101 is in the second state. With such a configuration, the image reading device 1A according to the present embodiment can reduce the degree of deceleration and suppress an increase in power consumption when the stopper 101 can suppress the medium 2 from moving more than expected in the discharge direction 18 when the medium 2 is discharged (first state). This is because, although power consumption in a motor that drives the discharge roller pair 17 increases by significantly changing a discharge speed of the medium 2 by the discharge roller pair 17, power consumption in the motor can be reduced by reducing the change in the discharge speed of the medium 2 by the discharge roller pair 17. Therefore, the image reading device 1A of the present embodiment can improve transportability of the medium 2 while suppressing power consumption.

Here, the first speed means a discharge speed immediately after the medium 2 is nipped by the discharge roller pair 17, and the second speed means a discharge speed immediately before the medium 2 nipped by the discharge roller pair 17 is discharged. In the image reading device 1A of the present embodiment, the first speed is the same regardless of a type of the medium 2, and the second speed is changed with respect to the first speed depending on a type of the medium 2. The second speed may be configured to be changeable to one speed different from the first speed depending on a type of the medium 2, or may be configured to be changeable to a plurality of speeds different from the first speed depending on a type of the medium 2.

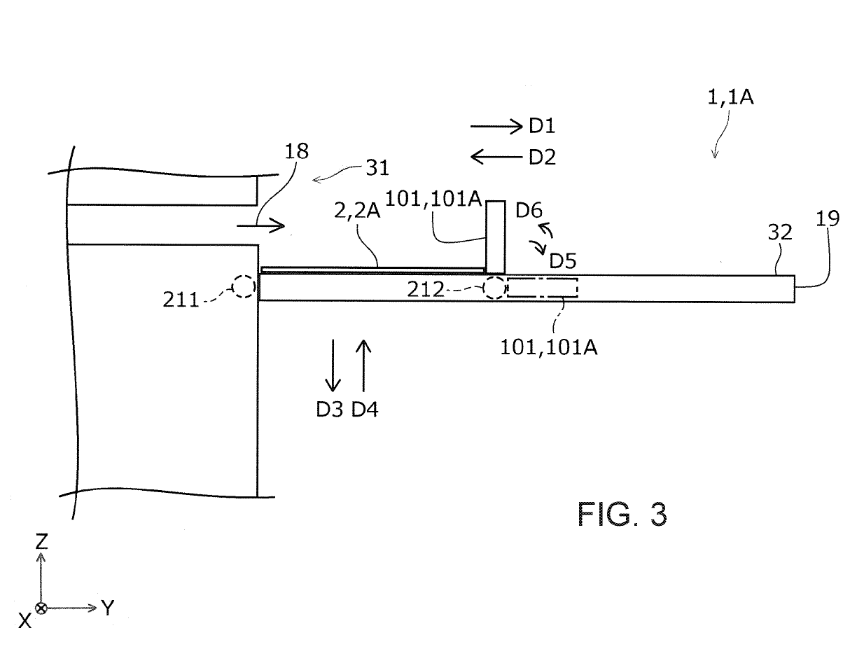

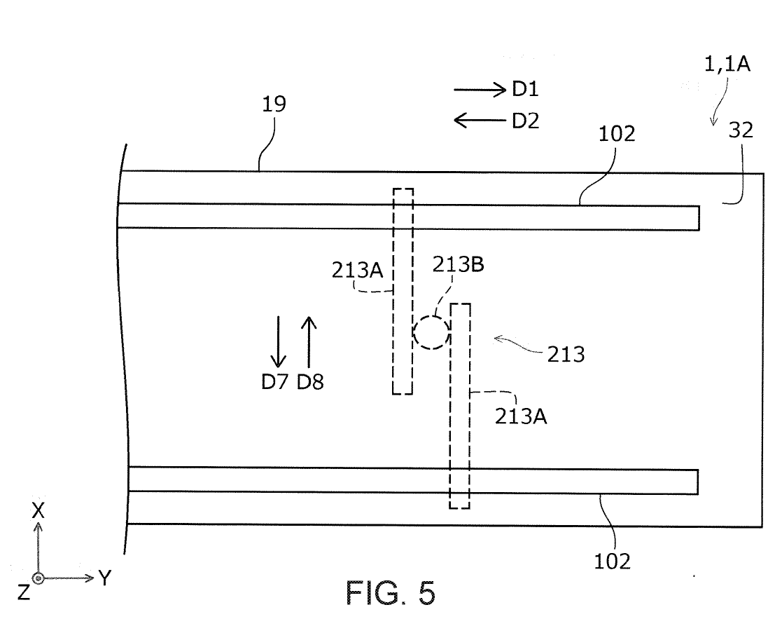

Hereinafter, the details of the discharge tray 19, such as the detailed configuration of the stopper 101, will be described. In addition to the stopper 101, the discharge tray 19 of the image reading device 1A of the present embodiment includes edge guides 102 for improving alignment of the medium 2 discharged to the discharge tray 19 in width directions D7 and D8, as illustrated in FIG. 5. The stopper 101 is configured to be movable in a direction D1 and a direction D2 corresponding to the discharge direction 18 as illustrated in FIG. 3, the discharge tray 19 is configured to be movable in a downward direction D3 and an upward direction D4 as illustrated in FIG. 3, and the edge guides 102 are configured to be movable in the width directions D7 and D8 as illustrated in FIG. 5. Here, the stopper 101, the discharge tray 19, and the edge guides 102 are configured to be movable under the control of the control section 22 that performs overall drive control of constituent members of the image reading device 1A of the present embodiment.

The electrical configuration of the image reading device 1A of the present embodiment based on the control section 22 will be described below with reference to FIG. 2. As illustrated in FIG. 2, the control section 22 includes the CPU 201, the ROM 202, the RAM 203, and the like. The control section 22 receives scan settings and the like in the first reading section 51 and the second reading section 52 by a setting receiving unit 205 that can receive instructions, settings, and the like from a user, which are represented by a type of medium 2 to be used, and stores the scan settings and the like as reading setting information and medium setting information in the RAM 203.

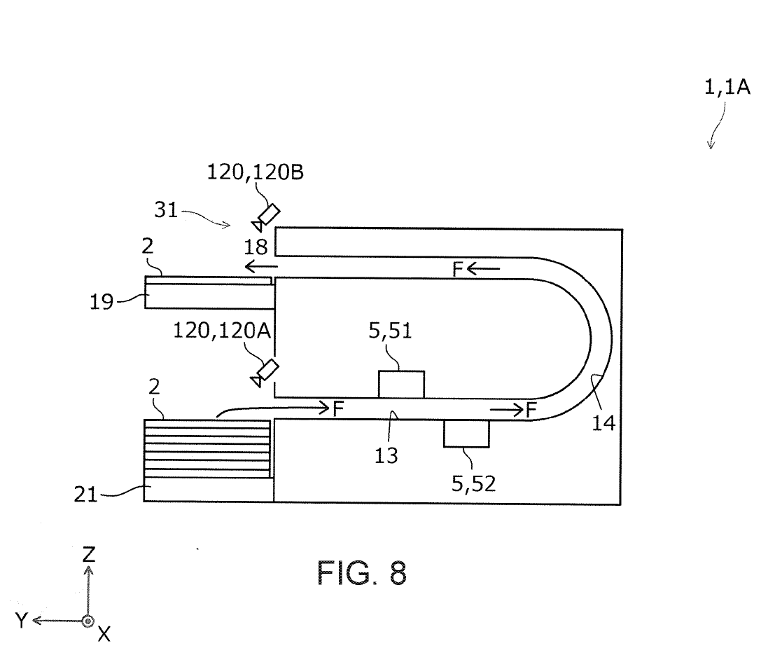

Here, the CPU 201 controls a control unit 209 for each transport roller pair, a control unit 210 for the discharge roller pair 17, a vertical movement unit 211 for the discharge tray 19, a deploy and store unit 212 for the stopper 101, and a movement unit 213 for the edge guides 102 based on instructions, settings, and the like from a user received via the setting receiving unit 205. As illustrated in FIG. 8, the image reading device 1A of the present embodiment includes two cameras 120, which are photographing sections. One of the cameras 120 is a first photographing section 120A capable of photographing an upward surface of the medium 2 supported on the feed tray 21, and the other of the cameras 120 is a second photographing section 120B capable of photographing an upward surface of the medium 2 supported on the discharge tray 19. The CPU 201 causes the first photographing section 120A and the second photographing section 120B, and the first reading section 51 and the second reading section 52 to acquire images, and causes the RAM 203 to store the acquired images as document images. That is, the first reading section 51 and the second reading section 52 also serve as the photographing section in the present disclosure. Further, the CPU 201 detects turned over medium 2 and the change in the order of the medium 2 consecutively transported based on the document images, and stores turned over detection result information and order change detection result information in the RAM 203.

The ROM 202 stores a scan setting reception program, a control program for each transport roller pair, a control program for the discharge roller pair 17, a vertical movement control program for the discharge tray 19, a deploy and store program for the stopper 101, and a movement program for the edge guides 102. Further, the ROM 202 stores a drive control program for the first photographing section 120A and the second photographing section 120B, a drive control program for the first reading section 51 and the second reading section 52, a turned over detection program for the medium 2, and a order change detection program for the medium 2.

As an information storage section, the RAM 203 stores photographing setting information and photographed images by the first photographing section 120A and the second photographing section 120B, reading setting information and read images by the first reading section 51 and the second reading section 52, turned over detection result information, order change detection result information, and various control parameter tables. Examples of the various control parameter tables include tables of control parameters of the transport roller pair, control parameters of the discharge roller pair 17, vertical movement control parameters of the discharge tray 19, deploy and store control parameters of the stopper 101, movement control parameters of the edge guides 102, and the like.

The control unit 209 for each transport roller pair controls a rotation speed of the first transport roller pair 7, a rotation speed of the second transport roller pair 8, and the like based on the acquired control parameters. The control unit 210 for the discharge roller pair 17 controls a rotation speed of the discharge roller pair 17 based on the acquired control parameters. The vertical movement unit 211 for the discharge tray 19 controls a raising and lowering mechanism of the discharge tray 19 including a motor (not illustrated) or the like based on the acquired control parameters. The deploy and store unit 212 for the stopper 101 controls the deploy and store of the stopper 101, which is composed of a motor 212C or the like, based on the acquired control parameters. The movement unit 213 for the edge guides 102 controls an adjustment mechanism of the edge guides 102, which is composed of a motor (not illustrated) or the like based on the acquired control parameters.

The image reading device 1A of the present embodiment includes such a control section 22, and thus, under the control of the control section 22, the stopper 101 can be automatically displaced between the first state and the second state depending on a type of the medium 2 to be used, which was received as an instruction from a user via the setting receiving unit 205. Here, a type of the medium 2 includes, for example, the material, size, thickness, and the like of the medium. Depending on the type of the medium 2, there are cases where the stopper 101 needs to be set to the first state and cases where the stopper 101 does not need to be set to the first state, but by adopting a configuration of the image reading device 1A of the present embodiment, the stopper 101 can be suitably displaced to the first state and the second state depending on a type of medium 2. The more types of the medium 2 the stopper 101 is deployed to be in the first state, the greater the effect of energy saving.

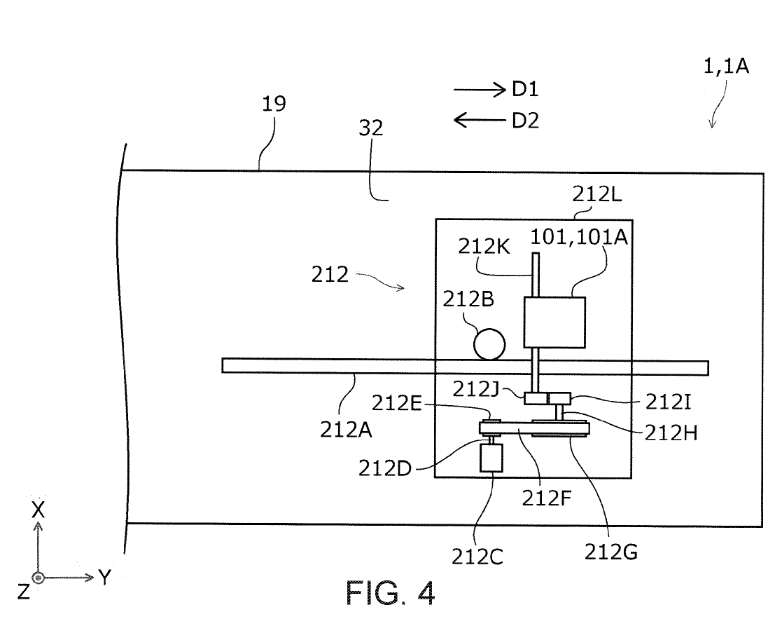

Here, the stopper 101 indicated by solid line in FIG. 3 represents a state in which the stopper 101 is deployed from the placement surface 32 of the discharge tray 19 and is in the first state, and the stopper 130 indicated by one dot chain line in FIG. 3 represents a state in which the stopper 101 is stored in the discharge tray 19 and is in the second state. A stopper 101A of the present embodiment as the stopper 101 enters the second state by pivoting from the first state in a pivot direction D5 with respect to the placement surface 32, and enters the first state by pivoting from the second state in a pivot direction D6 with respect to the placement surface 32. As illustrated in FIG. 4, the deploy and store unit 212 for the stopper 101 is provided on a unit base 212L that is movable in the direction D1 and in the direction D2 with respect to the placement surface 32. A rack 212A is fixed to the discharge tray 19, and a pinion 212B that engages with the rack 212A is provided on the unit base 212L.

Furthermore, as illustrated in FIG. 4, the unit base 212L is provided with the motor 212C, a pinion 212E attached to a rotation shaft 212D of the motor 212C, a pulley 212G that is connected to the pinion 212E by an endless belt 212F, a gear 212I connected to a rotation shaft 212H that is connected to the pulley 212G, a gear 212J that meshes with the gear 212I, and the stopper 101A connected to a rotation shaft 212K that is connected to the gear 212J. The control section 22 can displace the stopper 101A between the first state and the second state by driving the motor 212C, and can move the stopper 101A together with the unit base 212L in the direction D1 and in the direction D2 by driving a motor (not illustrated) to rotate the pinion 212B.

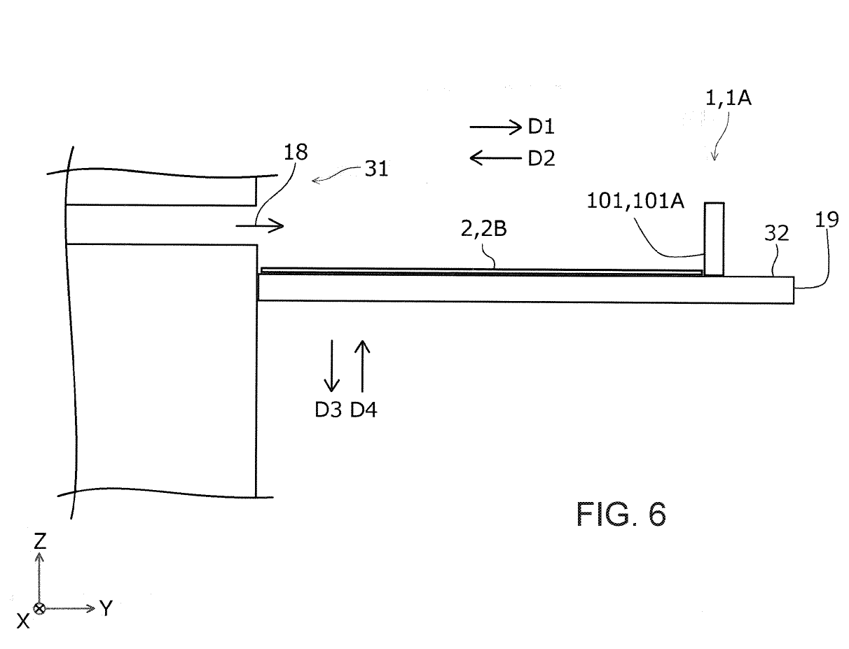

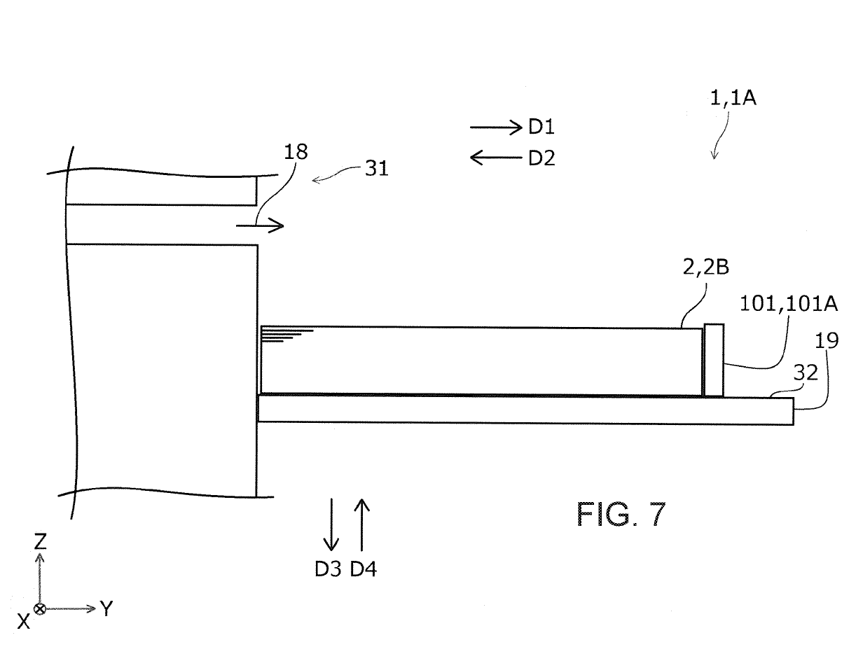

As described above, the image reading device 1A of the present embodiment can automatically change a position of the stopper 101A in the discharge direction 18 depending on a size of the medium 2 by moving the stopper 101A together with the unit base 212L in the direction D1 and in the direction D2 under the control of the control section 22. With such a configuration of the image reading device 1A of the present embodiment, when a size of the medium 2 is large, such as a medium 2B illustrated in FIGS. 6 and 7, the stopper 101A can be positioned downstream of the discharge direction 18, and when a size of the medium 2 is small, such as a medium 2A illustrated in FIG. 3, the stopper 101A can be positioned upstream of the discharge direction 18. That is, the image reading device 1A of the present embodiment can improve alignment of the medium 2 on the placement surface 32 for the medium 2 of various sizes, and can suitably improve transportability of the medium 2.

Note that FIG. 3 illustrates a state in which the small-sized medium 2 is supported on the placement surface 32 of the discharge tray 19, and FIG. 6 illustrates a state in which the large-sized medium 2 is supported on the placement surface 32 of the discharge tray 19. Specifically, a position of the stopper 101A in the direction D1 and in the direction D2 can be changed depending on, for example, when the medium 2 of A3 size is used, when the medium 2 of A4 size is used, and when the medium 2 of postcard size is used. Size of the medium 2 means a length in the transport direction in a case of a lengthwise placement of the medium 2 (in a case where the longer side is supported in the transport direction) and a widthwise placement of the medium 2 (in a case where the longer side is supported in the width direction). That is, when the medium 2 is supported lengthwise, the stopper 101A is moved in the direction D1, and when the medium 2 is supported widthwise, the stopper 101A is moved in the direction D2.

As described above, the image reading device 1A of the present embodiment includes the vertical movement unit 211 of the discharge tray 19. In the image reading device 1A of the present embodiment, the control section 22 controls the vertical movement unit 211 of the discharge tray 19, and thus the discharge tray 19 can change a position of the placement surface 32 with respect to the discharge section 31 in the downward direction D3 and the upward direction D4 corresponding to the placement direction of the medium 2 depending on a placed amount of the medium 2 that was placed on the placement surface 32. With such a configuration, the image reading device 1A of the present embodiment can set a position of the placement surface 32 to a position (upper side) close to the discharge section 31 as illustrated in FIG. 6 when a placed amount of the medium 2 is small, and can set the position of the placement surface 32 to a position (lower side) far from the discharge section 31 as illustrated in FIG. 7 as the placed amount of the medium 2 increases. That is, the image reading device 1A of the present embodiment can improve alignment of the medium 2 on the placement surface 32 depending on a placed amount of the medium 2, and can suitably improve transportability of the medium 2.

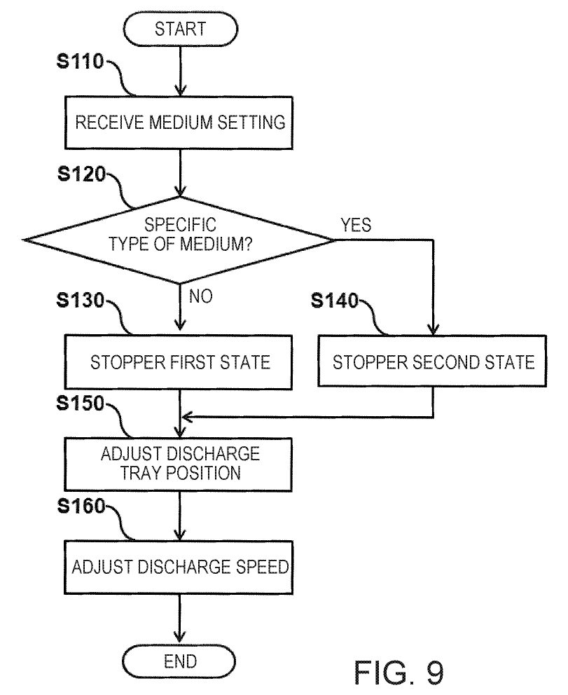

Here, an example of a flow of determining in the control section 22 whether the stopper 101A is to be set to the first state or to the second state and discharging the medium 2 to the discharge tray 19 using the image reading device 1A of the present embodiment will be described with reference to a flowchart of FIG. 9. In this flow, first, in step S110, the setting of the medium 2, such as a type of the medium 2 to be used and an instruction of whether the medium 2 is supported lengthwise or widthwise, is received from a user via the setting receiving unit 205.

Next, in step S120, the control section 22 determines whether the medium 2 to be used is of a type for which the stopper 101A should be set to the first state, or whether the medium 2 to be used is of a type for which the stopper 101A should be set to the second state. When the control section 22 determines that the medium 2 to be used is a type for which the stopper 101A should be set to the first state, the process proceeds to step S130, and when the control section 22 determines that the medium 2 to be used is a type for which the stopper 101A should be set to the second state, the process proceeds to step S140. An example of a type of the medium 2 to be used that requires the stopper 101A to be set to the first state is copy paper, and an example of a type of the medium 2 to be used that requires that the stopper 101A be set to the second state is thin paper that is thin and has low stiffness.

In step S130, the stopper 101A is set to the first state (a state of being deployed from the placement surface 32 of the discharge tray 19) as represented by solid line in FIG. 3, and in step S140, the stopper 101A is set to the second state (a state of being stored in the discharge tray 19) as represented by one dot chain line in FIG. 3. After step S130 or step S140 is completed, a position of the discharge tray 19 in the vertical direction is adjusted in step S150. For example, in a case where a thick paper or the like is used as the medium 2, even when a first sheet is supported on the placement surface 32 of the discharge tray 19, a position of the placement surface 32 can be set to a position (lower side) far from the discharge section 31.

Next, in step S160, a discharge speed (second speed) of the medium 2 discharged from discharge section 31 is adjusted by the control of control section 22, and medium 2 are discharged so as to have the adjusted discharge speed (second speed). For example, when thin paper or the like is used as the medium 2, the discharge speed (second speed) can be decreased. That is, when the medium 2 to be used is of a type that should cause the stopper 101A to be in the first state, the normal discharge speed (second speed) can be set, and when the medium 2 to be used is of a type that should cause the stopper 101A to be in the second state, a discharge speed (second speed) slower than the normal discharge speed (second speed) can be set. Then, the flow illustrated in the flowchart of FIG. 9 is ended with the end of step S160.

As described above, the image reading device 1A of the present embodiment includes the cameras 120 as the photographing sections that photograph the medium 2, and the deploy and store unit 212 of the stopper 101 as a displacement mechanism that displaces the stopper 101A between the first state and the second state. In the image reading device 1A of the present embodiment, the deploy and store unit 212 of the stopper 101 is configured to be able to displace the stopper 101A to the first state and to the second state based on image data of the medium 2 photographed by the cameras 120 under the control of the control section 22.

With such a configuration, the image reading device 1A of the present embodiment can suitably displace the stopper 101A to the first state and the second state based on image data of the medium 2 photographed by the cameras 120. That is, the image reading device 1A of the present embodiment can improve transportability of the medium 2 based on image data of the medium 2. Here, the cameras 120 as the photographing section of the present embodiment are high-precision video cameras, but a smartphone with a built-in camera, a portable small camera, or the like may be used instead of the cameras 120.

From another viewpoint, the image reading device 1A of the present embodiment includes the feed tray 21 on which the medium 2 is supported, the pickup roller 12 that feeds the medium 2 supported on the feed tray 21, the discharge section 31 that can discharge the medium 2 fed by the pickup roller 12, the discharge tray 19 including the placement surface 32 on which the medium 2 discharged from the discharge section 31 is supported, the cameras 120 that photograph the medium 2, and the control section 22. The control section 22 can cause the cameras 120 to photograph the medium 2 both before the medium 2 is discharged from the discharge section 31 and during or after the medium 2 is discharged from the discharge section 31. Furthermore, based on image data of one surface of the medium 2 before being discharged from the discharge section 31 and image data of one surface of the medium 2 during or after being discharged from the discharge section 31, the control section 22 can determine the state of the medium 2 after it was discharged from the discharge section 31.

With such a configuration, the image reading device 1A of the present embodiment can suitably determine a state of the medium 2 after it was discharged based on the image data of the medium 2 photographed by the cameras 120. That is, the image reading device 1A of present embodiment can suitably improve transportability of the medium 2 based on image data of the medium 2 even when, for example, there is no input of information about the medium 2 from a user. A state of the medium 2 corresponds to the front and back of the medium 2, a type of an image formed on the medium 2, a size of the medium 2, and the like. By determining a state of the medium 2, it is possible to recognize a change in the order of the medium 2 or turned over medium 2. With such a configuration, the image reading device 1A of the present embodiment can adjust a discharge speed of the medium 2 by the discharge roller pair 17 based on a state of the medium 2 determined by the control section 22, and can reduce the opportunity of increasing power consumption by significantly decelerating the discharge speed of the medium 2 by the discharge roller pair 17. When the image reading device 1A of the present embodiment recognizes a change in the order or a turned over medium 2, the image reading device 1A can notify the change in the order or the turned over medium 2 as an error message, for example, on a display section (not illustrated) or an external computer via the setting receiving unit 205.

Specifically, as illustrated in FIG. 8, in the image reading device 1A of the present embodiment, the medium 2 supported on the feed tray 21 before being transported are transported in order from the top when a plurality of sheets of the medium 2 are stacked by the pickup roller 12. The control section 22 can cause the first photographing section 120A of the cameras 120 to photograph the uppermost sheet of the medium 2 supported on the feed tray 21 from above, and cause the second photographing section 120B of the cameras 120 to photograph the medium 2 during or after being discharged from the discharge section 31 from above. Then, the control section 22 can determine a state of the medium 2 after being discharged from the discharge section 31 based on image data of the medium 2 supported on the feed tray 21 and image data of the medium 2 during or after being discharged from the discharge section 31. With such a configuration, the image reading device 1A of the present embodiment can suitably determine a state of the medium 2 after being discharged from the discharge section 31 by comparing image data of the medium 2 supported on the feed tray 21 with image data of the medium 2 during or after being discharged from the discharge section 31, and can suitably detect a change in the order of the medium 2, a turned over medium 2, and the like. For example, when image data of the medium 2 photographed by the first photographing section 120A of the cameras 120 is different from image data of the medium 2 photographed by the second photographing section 120B of the cameras 120, it is determined that the medium 2 has not turned over, and when the image data is the same, it is determined that the medium 2 turned over.

In the image reading device 1A of the present embodiment, the first reading section 51 and the second reading section 52 that also serve as the photographing section are provided in the transport path 3. The control section 22 can cause the first reading section 51 and the second reading section 52 to photograph (read) the medium 2 being transported on the transport path 3 from the feed tray 21 to the discharge section 31, and can cause the second photographing section 120B of the cameras 120 to photograph the medium 2 during or after it is discharged from the discharge section 31. Then, the state of the medium 2 after being discharged from the discharge section 31 can be determined based on image data of the medium 2 being transported on the transport path 3 and image data of the medium 2 during or after being discharged from the discharge section 31. With such a configuration, the image reading device 1A of the present embodiment can suitably determine a state of the medium 2 after being discharged from the discharge section 31 by comparing image data of the medium 2 being transported on the transport path 3 with image data of the medium 2 during or after being discharged from the discharge section 31, and can suitably detect the change in the order of the medium 2, a turned over medium 2, and the like.

For example, when image data of the medium 2 photographed by the second reading section 52 is the same as image data of the medium 2 photographed by the second photographing section 120B of the cameras 120, it can be determined that the medium 2 was not turned over. On the other hand, when image data of the medium 2 photographed by the first reading section 51 is the same as image data of the medium 2 photographed by the second photographing section 120B of the cameras 120, it can be determined that the medium 2 was turned over. Further, when image data of the medium 2 photographed by the first reading section 51, image data of the medium 2 photographed by the second reading section 52, and image data of the medium 2 photographed by the second photographing section 120B of the cameras 120 are all different, it can be determined that the order changed.

Here, as illustrated in FIG. 5, the image reading device 1A of the present embodiment includes the edge guides 102 on the discharge tray 19. The edge guides 102 are configured to be movable in the width directions D7 and D8, which are directions intersecting the discharge direction 18 of the medium 2. In the image reading device 1A of the present embodiment, the control section 22 can cause at least one of the first photographing section 120A and the second photographing section 120B of the cameras 120 to photograph the medium 2 supported on the discharge tray 19, and move the edge guides 102 based on image data of the medium 2 photographed by the cameras 120. With such a configuration, the image reading device 1A of the present embodiment can arrange the edge guides 102 at a suitable position, can improve alignment of the medium 2 on the placement surface 32, and can improve transportability of the medium 2.

Here, details of the movement unit 213 of the edge guides 102 that moves the edge guides 102 will be described. As illustrated in FIG. 5, the two edge guides 102 are connected to racks 213A extending in the width directions D7 and D8. A pinion 213B is provided at a position where the pinion 213B engages to the two racks 213A. The pinion 213B is fixed to the discharge tray 19 and is connected to a motor (not illustrated). As the pinion 213B is driven, the edge guides 102 move together with the racks 213A in the width directions D7 and D8.

In the image reading device 1A of the present embodiment, edge guides including the same configuration as the edge guides 102 are also provided on the feed tray 21. That is, the feed tray 21 includes the edge guides that can move in a direction intersecting a feed direction of the medium 2, and the control section 22 can cause the first photographing section 120A of the cameras 120 to photograph the medium 2 supported on the feed tray 21, and can move the edge guides provided on the feed tray 21 based on image data of the medium 2 photographed by the first photographing section 120A. With such a configuration, the image reading device 1A of the present embodiment can arrange the edge guides at a suitable position, can improve alignment of the medium 2 on the feed tray 21, and can improve transportability of the medium 2.

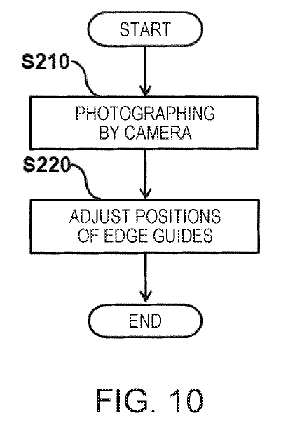

Here, with reference to the flowchart of FIG. 10, an example will be described of the flow for determining the width of the medium 2 and for adjusting positions of the edge guides 102 in the control section 22 from a photographic result of the cameras 120 using the image reading device 1A of the present embodiment. In this flow, first, in step S210, the medium 2 supported on the discharge tray 19 is photographed by the second photographing section 120B of the cameras 120. Next, in step S220, the edge guides 102 are moved based on image data of the medium 2 supported on the discharge tray 19 by the control of the control section 22. Note that by rereading the discharge tray 19 to be the feed tray 21 and rereading the second photographing section 120B to be the first photographing section 120A, it is possible to consider the flow as a flow for adjusting positions of the edge guides formed on the feed tray 21.

In the image reading device 1A of the present embodiment, the control section 22 can cause the first photographing section 120A of the cameras 120 to photograph the medium 2 supported on the feed tray 21, and can displace the stopper 101A to the first state and to the second state based on image data of the medium 2 supported on the feed tray 21. With such a configuration, the image reading device 1A of the present embodiment can suitably determine whether to displace the stopper 101A to the first state or to the second state, and by setting the stopper 101A to the first state as necessary, it is possible to suppress a part of the medium 2 discharged to the discharge tray 19 from moving too far in the discharge direction 18 when the medium 2 is consecutively placed on the discharge tray 19. That is, the image reading device 1A of the present embodiment can improve transportability of the medium 2.

In the image reading device 1A of the present embodiment, the control section 22 can cause the cameras 120 to photograph a part of the medium 2, for example, an end section or four corners of the medium 2, instead of the entire medium 2. The image reading device 1A of the present embodiment is configured as described above, and thus the image data amount of the medium 2 generated by photographing with the cameras 120 can be reduced, and data processing time can be shortened.

Further, in the image reading device 1A of the present embodiment, the control section 22 can determine a state of the medium 2 after being discharged from the discharge section 31 based on a part of image data of one surface of the medium 2 before being discharged from the discharge section 31, for example, image data of an end section, four corners, or the like of an image formed on the medium 2, and a part of image data of one surface of the medium 2 during or after being discharged from the discharge section 31, for example, image data of an end section, four corners, or the like of an image formed on the medium 2. The image reading device 1A of the present embodiment is configured as described above, and thus, it is possible to reduce data processing time.

In summary, with the above-described configuration, the image reading device 1A of the present embodiment can reduce power consumption that occurs when the medium 2 is discharged (during deceleration) from the discharge section 31 by controlling the raising and lowering of the discharge tray 19 and the deploy and store of the stopper 101A, while also achieving improved transportability, such as improved alignment of the medium 2 discharged to the discharge tray 19. In the related art image reading device, even if the order of the medium 2 changes or the medium 2 is turned over (a so-called stacking failure) in a bundle of the medium 2 that has been completely discharged, a scanning operation or the like may be normally ended unless another error such as a jam or an excessive load occurs, and thus a user is unlikely to notice the stacking failure. On the other hand, even if a user notices a stacking failure, a transport operation of the medium 2 is not stopped unless an error occurs. Therefore, it is necessary for a user to stop the transport of the medium 2 in the middle or to wait until the transport of all the medium 2 is completed and then search for the medium 2 that caused the stacking failure. In this case, it is difficult to find the medium 2 that caused the stacking failure, except for a case where a page number is described on the medium 2 as a document or a case where the correct order of the medium 2 can be clarified from the previous and subsequent page numbers. By using the image reading device 1A of the present embodiment, a user can notice the stacking failure and can easily know which medium 2 caused the stacking failure.

### SECOND EMBODIMENT

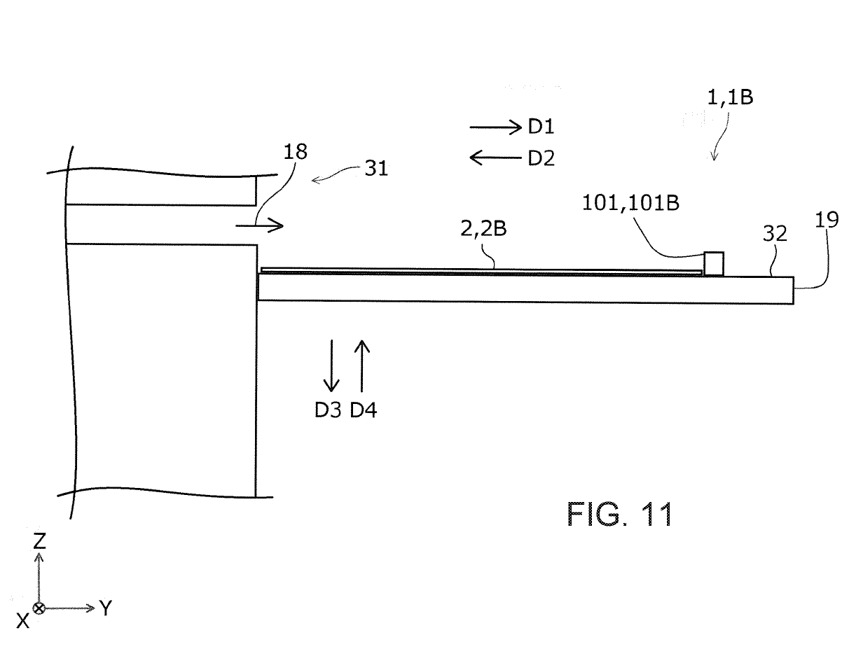

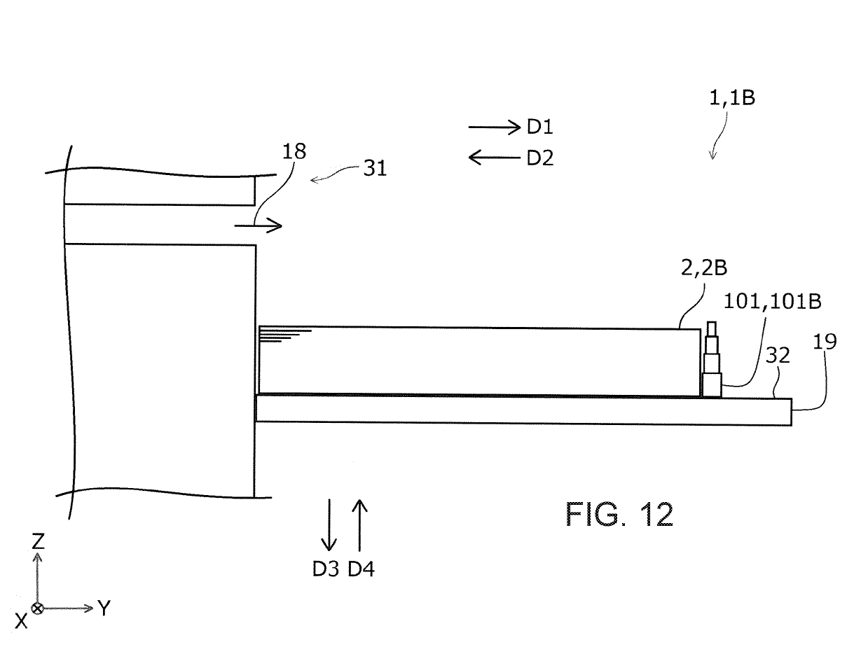

Next, an image reading device 1B according to a second embodiment will be described with reference to FIGS. 11 and 12. Here, FIG. 11 corresponds to FIG. 6 in the image reading device 1A of the first embodiment, and FIG. 12 corresponds to FIG. 7 in the image reading device 1A of the first embodiment. The image reading device 1B of the present embodiment is the same as the image reading device 1A of the first embodiment except for the following description, and thus has the same features as the image reading device 1A of the first embodiment. Therefore, in FIGS. 11 and 12, the same reference symbols are given to the same components as those in the first embodiment, and the detailed description thereof will be omitted.

As illustrated in FIGS. 11 and 12, the image reading device 1B of the present embodiment is configured such that the stopper 101 is expandable and contractible depending on a placed amount of the medium 2 that was placed on the discharge tray 19 in the first state. In other words, a stopper 101B of the image reading device 1B of the present embodiment is configured such that a protrusion amount with respect to the placement surface 32 in the first state can be changed depending on a placed amount of the medium 2 that was placed on the placement surface 32.

With such a configuration, the image reading device 1B of the present embodiment can reduce the protrusion amount of the stopper 101B when a placed amount of the medium 2 is small as illustrated in FIG. 11, and can increase the protrusion amount of the stopper 101B as a placed amount of the medium 2 increases as illustrated in FIG. 12. That is, the image reading device 1B of the present embodiment can improve alignment of the medium 2 on the placement surface 32 depending on a placed amount of the medium 2, and can suitably improve transportability of the medium 2.

### THIRD EMBODIMENT

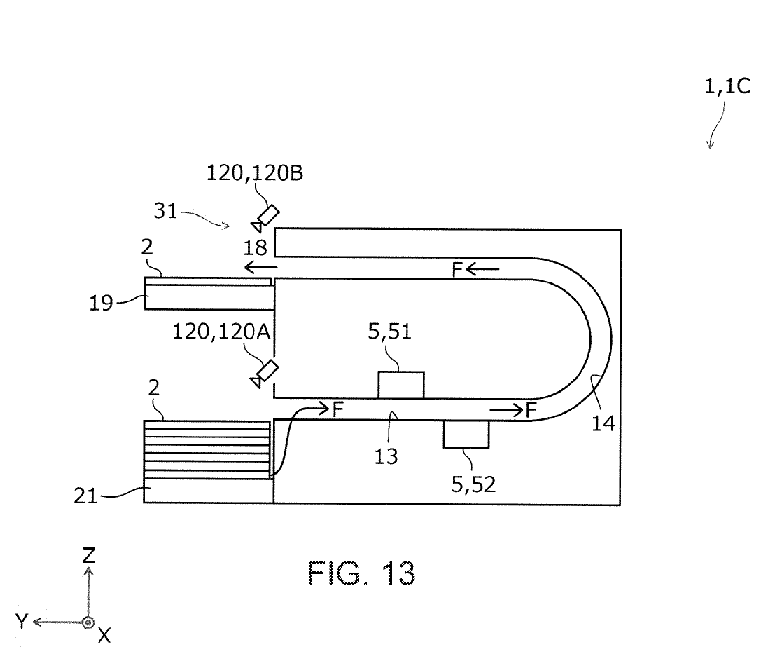

Next, an image reading device 1C according to a third embodiment will be described with reference to FIG. 13. Here, FIG. 13 corresponds to FIG. 8 in the image reading device 1A of the first embodiment. The image reading device 1C of the present embodiment is the same as the image reading device 1A of the first embodiment except for the following description, and thus has the same features as the image reading device 1A of the first embodiment. Therefore, in FIG. 13, the same reference symbols are given to the same components as those in the first embodiment, and the detailed description thereof will be omitted.

As described above, in the image reading device 1A according to the first embodiment, the medium 2 supported on the feed tray 21 before being transported is transported in order from the top when a plurality of sheets of the medium 2 are stacked. Therefore, in the image reading device 1A of the first embodiment, it is determined that the medium 2 has not turned over when image data of the medium 2 photographed by the first photographing section 120A is different from image data of the medium 2 photographed by the second photographing section 120B, and it is determined that the medium 2 turned over when the image data is the same. Further, in the image reading device 1A of the first embodiment, the second reading section 52 is caused to photograph the medium 2, and when image data of the medium 2 photographed by the second reading section 52 is the same as image data of the medium 2 photographed by the second photographing section 120B, it can be determined that the medium 2 did not turned over.

On the other hand, in the image reading device 1C of the present embodiment, as illustrated in FIG. 13, the medium 2 supported on the feed tray 21 before being transported is transported in order from the bottom when a plurality of sheets of the medium 2 are stacked. Therefore, unlike the image reading device 1A of the first embodiment, the image reading device 1C of the present embodiment cannot determine whether the medium 2 is turned over by simply comparing image data of the medium 2 photographed by the first photographing section 120A with image data of the medium 2 photographed by the second photographing section 120B.

In the image reading device 1C of the present embodiment, the second reading section 52 is caused to photograph the medium 2, and when image data of the medium 2 photographed by the second reading section 52 is the same as image data of the medium 2 photographed by the second photographing section 120B, it is determined that the medium 2 is not turned over. As with the image reading device 1A of the first embodiment, when image data of the medium 2 photographed by the first reading section 51, image data of medium 2 photographed by the second reading section 52, and image data of medium 2 photographed by the second photographing section 120B are all different, it can be determined that the change in order occurred.

### FOURTH EMBODIMENT

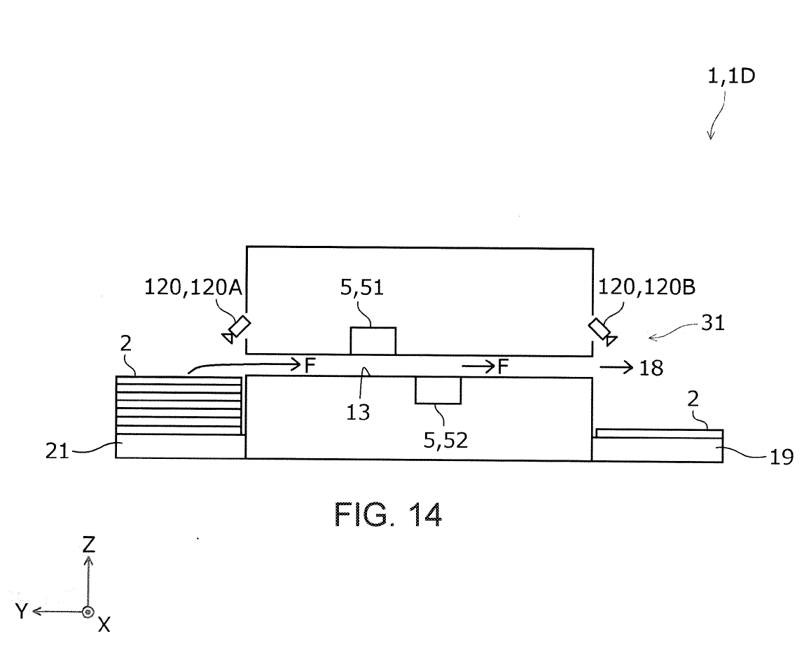

Next, an image reading device 1D according to a fourth embodiment will be described with reference to FIG. 14. Here, FIG. 14 corresponds to FIG. 8 in the image reading device 1A of the first embodiment. The image reading device 1D of the present embodiment is the same as the image reading device 1A of the first embodiment except for the following description, and thus has the same features as the image reading device 1A of the first embodiment. Therefore, in FIG. 14, the same reference symbols are given to the same components as those in the first embodiment, and the detailed description thereof will be omitted.

As described above, the image reading device 1A of the first embodiment includes the U-turn path 14, and the feed tray 21 and the discharge tray 19 are formed on the same side in the Y-axis direction with respect to a device main body. That is, in a case where the medium 2 is transported from the feed tray 21 to the discharge tray 19 without being turned over, different surfaces of the medium 2 face upward while supported on the feed tray 21 and while supported on the discharge tray 19. Therefore, in the image reading device 1A of the first embodiment, it is determined that the medium 2 has not turned over when image data of the medium 2 photographed by the first photographing section 120A is different from image data of the medium 2 photographed by the second photographing section 120B, and it is determined that the medium 2 turned over when the image data is the same.

On the other hand, in the image reading device 1D of the present embodiment, as illustrated in FIG. 14, the U-turn path 14 is not provided, and the feed tray 21 and the discharge tray 19 are formed on different sides in the Y-axis direction with respect to the device main body. That is, in a case where the medium 2 is transported from the feed tray 21 to the discharge tray 19 without being turned over, the same surface of the medium 2 faces upward when the medium 2 is supported on the feed tray 21 and when the medium 2 is supported on the discharge tray 19. Therefore, in contrast to the image reading device 1A of the first embodiment, in the image reading device 1D of the present embodiment, it is possible to determine that there is no turnover when image data of the medium 2 photographed by the first photographing section 120A and image data of the medium 2 photographed by the second photographing section 120B are the same, and it is possible to determine that there is turnover when the image data is different.

### FIFTH EMBODIMENT

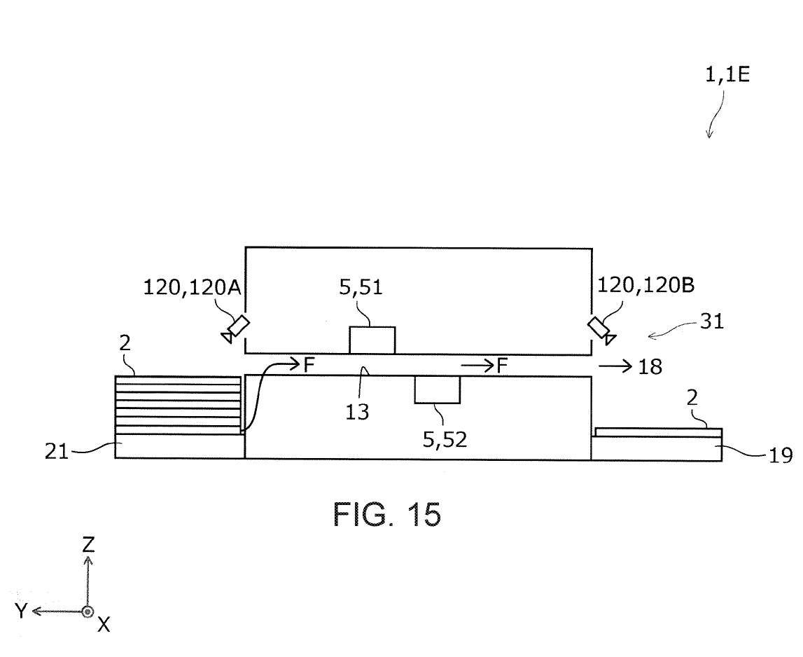

Next, an image reading device 1E according to a fifth embodiment will be described with reference to FIG. 15. Here, FIG. 15 corresponds to FIG. 8 in the image reading device 1A of the first embodiment. The image reading device 1E of the present embodiment is the same as the image reading device 1A of the first embodiment except for the following description, and thus has the same features as the image reading device 1A of the first embodiment. Therefore, in FIG. 15, the same reference symbols are given to the same components as those in the first embodiment, and the detailed description thereof will be omitted.

As illustrated in FIG. 15, the image reading device 1E of the present embodiment does not include the U-turn path 14, and the feed tray 21 and the discharge tray 19 are formed on different sides in the Y-axis direction with respect to the device main body, similarly to the image reading device 1D of the fourth embodiment. However, whereas the image reading device 1D of the fourth embodiment is configured so that when a plurality of sheets of the medium 2 are stacked on the feed tray 21 before being transported, they are transported in order from the top, the image reading device 1E of the present embodiment is configured so that when a plurality of sheets of the medium 2 are stacked on the feed tray 21 before being transported, they are transported in order from the bottom.

Therefore, unlike the image reading device 1A of the first embodiment and the image reading device 1D of the fourth embodiment, in the image reading device 1E of the present embodiment, it is not possible to determine whether or not the medium 2 is turned over by only comparing image data of the medium 2 photographed by the first photographing section 120A and image data of the medium 2 photographed by the second photographing section 120B. In the image reading device 1E of the present embodiment, the first reading section 51 is caused to photograph the medium 2, and it is determined that there is no turnover when image data of the medium 2 photographed by the first reading section 51 is the same as image data of the medium 2 photographed by the second photographing section 120B. As with the image reading device 1A of the first embodiment, when image data of the medium 2 photographed by the first reading section 51, image data of medium 2 photographed by the second reading section 52, and image data of medium 2 photographed by the second photographing section 120B are all different, it can be determined that the change in order occurred.

The present disclosure is not limited to the above-described embodiments, and can be realized by various configurations without departing from the scope of the disclosure. In addition, the technical features in the embodiments corresponding to the technical features in the aspects described in the summary section can be replaced or combined as appropriate in order to overcome some or all of the above-described problems or in order to achieve some or all of the above-described effects. If the technical features are not described as essential in the present specification, the technical features can be appropriately omitted.

What is claimed is:

1. A medium transport device comprising:
a discharge section including a discharge roller configured to discharge a medium;
a discharge tray including a placement surface that supports the medium discharged from the discharge section; and
a stopper that is provided on the discharge tray and that is configured to be displaced between a first state in which the stopper protrudes from the placement surface to restrict movement of discharged medium in a discharge direction and a second state in which the stopper does not protrude from the placement surface to allow movement of the medium in the discharge direction, wherein
the discharge section is configured to decelerate a discharge speed of the medium by the discharge roller when discharging the medium from a first speed to a second speed and
a degree of deceleration from the first speed to the second speed is smaller when the stopper is in the first state than when the stopper is in the second state.

2. The medium transport device according to claim 1, wherein
the stopper is configured to be displaced between the first state and the second state depending on a type of the medium.

3. The medium transport device according to claim 1, wherein
the stopper is configured to change a position in the discharge direction depending on a size of the medium.

4. The medium transport device according to claim 1, wherein
the stopper is configured to change a protrusion amount with respect to the placement surface in the first state depending on a placed amount of the medium that was placed on the placement surface.

5. The medium transport device according to claim 1, wherein
the discharge tray is configured to change a position of the placement surface with respect to the discharge section in a placement direction of the medium depending on a placed amount of the medium that was placed on the placement surface.

6. The medium transport device according to claim 1, further comprising:
a photographing section that photographs the medium and
a displacement mechanism that displaces the stopper between the first state and the second state, wherein
the displacement mechanism is configured to displace the stopper between the first state and the second state based on image data of the medium photographed by the photographing section.

7. A medium transport device comprising:
a feed tray that supports a medium;
a feeding section that feeds the medium supported on the feed tray;
a discharge section configured to discharge the medium fed by the feeding section;
a discharge tray including a placement surface that supports the medium discharged from the discharge section;
a photographing section that photographs the medium; and
a control section, wherein
the control section
causes the photographing section to photograph the medium both before the medium is discharged from the discharge section and during or after the medium is discharged from the discharge section, and
determines a state of the medium after the medium is discharged from the discharge section based on image data of one surface of the medium before the medium is discharged from the discharge section and image data of the one surface of the medium during or after the medium is discharged from the discharge section.

8. The medium transport device according to claim 7, wherein
the control section
causes the photographing section to photograph the medium supported on the feed tray and also to photograph the medium being discharged or after being discharged from the discharge section, and
determines a state of the medium after the medium is discharged from the discharge section based on image data of the medium supported on the feed tray and image data of the medium being discharged or after being discharged from the discharge section.

9. The medium transport device according to claim 7, wherein
the control section
causes the photographing section to photograph the medium being transported in a transport path from the feed tray to the discharge section and also to photograph the medium being discharged or after being discharged from the discharge section, and
determines a state of the medium after the medium is discharged from the discharge section based on image data of the medium being transported on the transport path and image data of the medium being discharged or after being discharged from the discharge section.

10. The medium transport device according to claim 7, wherein
the feed tray includes an edge guide configured to move in a direction intersecting a feed direction of the medium and
the control section causes the photographing section to photograph the medium supported on the feed tray, and moves the edge guide based on image data of the medium photographed by the photographing section.

11. The medium transport device according to claim 7, wherein
the discharge tray includes an edge guide configured to move in a direction intersecting a discharge direction of the medium and
the control section causes the photographing section to photograph at least one of the medium supported on the feed tray and the medium supported on the discharge tray, and moves the edge guide based on image data of the medium photographed by the photographing section.

12. The medium transport device according to claim 7, further comprising:
a stopper provided on the discharge tray and configured to be displaced between a first state in which the stopper protrudes from the placement surface to restrict movement of the discharged medium in a discharge direction and a second state in which the stopper has dropped down toward the placement surface to allow movement of the medium in the discharge direction, wherein
the control section causes the photographing section to photograph the medium supported on the feed tray, and displaces the stopper between the first state and the second state based on image data of the medium supported on the feed tray.

13. The medium transport device according to claim 7, wherein
the control section causes the photographing section to photograph a part of the medium.

14. The medium transport device according to claim 7, wherein
the control section determines a state of the medium after the medium is discharged from the discharge section based on a part of image data of one surface of the medium before being discharged from the discharge section and a part of image data of one surface of the medium during or after being discharged from the discharge section.

15. An image reading device comprising:
the medium transport device according to claim 1 and
an image reading section that reads an image formed on the medium.
